(19) United States
(12) Patent Application Publication
(10) Pub. No.: US 2026/0315199 A1
(43) Pub. Date: Oct. 15, 2026

(54) DENTURE CURING ASSEMBLY

(71) Applicant: Robert Bruce McDonald, Melbourne Beach, FL (US)

(72) Inventor: Robert Bruce McDonald, Melbourne Beach, FL (US)

(21) Appl. No.: 19/462,550

(22) Filed: Jan. 28, 2026

Related U.S. Application Data
(60) Provisional application No. 63/750,848, filed on Jan. 29, 2025.

(51) Int. Cl. A61C 13/00

(52) U.S. Cl. CPC A61C 13/0006

(57) ABSTRACT

A denture curing assembly according to the present invention may include a base and a pair of side members extending upwardly from the base. The denture curing assembly may also include a top connected to upper portions of the side members and extending between the side members. The top may have a passageway formed in a medial portion thereof. The denture curing assembly may also include a pressure cap positioned between the side members and longitudinally movable between a released position and a compressed position, and a shaft connected to the pressure cap to slidably engage the passageway formed in the medial portion of the top. Longitudinal movement of the shaft causes the pressure cap to move between the released position and the compressed position. A plurality of heating elements may be carried by at least one of the base and the pressure cap.

### RELATED APPLICATIONS

This application claims the benefit of U.S. Provisional Patent Application No. 63/750,848, filed Jan. 29, 2025, entitled “Denture Curing Assembly,” the entire contents of which are incorporated herein by reference except to the extent that any disclosure therein conflicts with disclosure herein.

### FIELD OF THE INVENTION

The present disclosure relates generally to dental prosthetics, and more particularly to assemblies and methods for curing dentures using controlled pressure and temperature to polymerize resin materials.

### BACKGROUND OF THE INVENTION

Dentures and dentures may generally be fabricated using pre-formed denture teeth made of poly methyl methacrylate (PMMA) resin supplied by a variety of manufacturers both in the US and abroad. The pink denture base is initially made of wax and a mold is made of the wax denture. The wax is then melted, and pink PMMA resin is mixed from a powder and liquid. The pink PMMA resin is then pressed into the mold. PMMA resins shrink approximately 5%-7% by volume upon polymerization resulting in dentures that do not fit accurately. Some dentures may be milled from PMMA discs using CNC milling equipment. However, these PMMA discs are only available in either pink gingiva colors, or white tooth colors. Therefore, the only way to make the denture is to separately mill the gum portion of the denture from a pink PMMA disc and the teeth portion of the denture from a white PMMA disc. The two resulting pieces are then generally glued together. This method of manufacture is labor intensive and does not produce as solid and reliable a product as a monolithically formed product. Therefore, an improvement of the current denture formation technology is needed.

### SUMMARY OF THE INVENTION

With the above in mind, the present invention is directed to a denture curing assembly that may include a base and a pair of side members extending upwardly from the base. The denture curing assembly according to the present invention may also include a top connected to upper portions of the side members. The top may also extend between the side members and may have a passageway formed in a medial portion thereof. The denture curing assembly of the present invention may also include a pressure cap positioned between the side members and longitudinally movable between a released position and a compressed position. The denture curing assembly of the present invention may further include a shaft connected to the pressure cap to slidably engage the passageway formed in the medial portion of the top. Longitudinal movement of the shaft causes the pressure cap to move between the released position and the compressed position.

A plurality of heating elements may be carried by at least one of the base and the pressure cap. The denture curing assembly may also include a pressure valve in communication with the pressure cap and configured to apply pressure to an article positioned between the base and the pressure cap. The plurality of heating elements may include a first plurality of heating elements carried by the base and a second plurality of heating elements carried by the pressure cap.

The denture curing assembly may also include a temperature sensor carried by at least one of the base and the pressure cap. The denture curing assembly may further include a controller in communication with the at least one temperature sensor and the plurality of heating elements. The denture curing assembly may still further include a temperature gauge in communication with the at least one temperature sensor. The denture curing assembly may also include a timer connected to the controller. The timer may be configured to automatically deactivate the plurality of heating elements upon achieving a predetermined time.

The denture curing assembly according to the present invention may include a plurality of legs extending between the base and the top. The pressure cap may include a respective plurality of leg receiving passageways formed therethrough such that the pressure cap slidably engages the plurality of legs. The denture curing assembly may also include a respective plurality of spring members carried by the plurality of legs and positioned between an upper portion of the base and a lower portion of the pressure cap.

The base of the denture curing assembly according to the present invention may also include a cutout adapted to receive a denture holder. The pressure cap may include a pressure cap cutout formed in a lower portion thereof and adapted to receive an upper portion of the denture holder. The pressure valve may be configured to apply compressed air at a pressure of approximately 150 psi to the article positioned between the base and the pressure cap.

In one embodiment of the denture curing assembly according to the present invention, a pair of actuator side members may be connected to and extend upwardly from the top. In this embodiment of the denture curing assembly, an actuator may be connected to the actuator side members. Further, the shaft may be connected to an actuator. Movement of the actuator causes movement of the shaft to move the pressure cap between the released position and the compressed position.

In another embodiment of the denture curing assembly according to the present invention, the shaft may be threaded. The shaft may also be threadably carried by the top, and rotation of the shaft may cause the pressure cap to move between the released position and the compressed position. A handle may also be connected to an upper portion of the shaft.

### BRIEF DESCRIPTION OF THE DRAWINGS

FIG. 1 is a front perspective view of a denture curing assembly according to an embodiment of the present invention.

FIG. 2 is another front perspective view of the denture curing assembly shown in FIG. 1.

FIG. 3 is a front perspective view of the denture curing assembly shown in FIG. 1.

FIG. 4 is a rear perspective view of the denture curing assembly shown in FIG. 1.

FIG. 5 is a front elevation view of the denture curing assembly shown in FIG. 1.

FIG. 6 is a front perspective view of the denture curing assembly according to the present invention and including a controller.

FIG. 7 is a side view of the denture curing assembly shown in FIG. 6.

FIG. 8 is a rear perspective view of the denture curing assembly shown in FIG. 6.

FIG. 9 is a side perspective view of the denture curing assembly shown in FIG. 6.

FIG. 10 is rear perspective view of the denture curing assembly shown in FIG. 6.

FIG. 11 is a rear perspective view of the controller of the denture curing assembly shown in FIG. 6.

FIG. 12 is a rear perspective view of a denture curing assembly according to the present invention and having a denture being held in a denture holder and positioned between a base of the denture curing assembly and a pressure cap of the denture curing assembly with the pressure cap positioned in a compressed position.

FIG. 13 is a perspective view of a denture being held in a denture holder to be used in connection with the denture curing assembly according to the present invention.

FIG. 14 is a perspective view of a disc from which a denture is made.

FIG. 15 is another perspective view of the disc illustrated in FIG. 14.

FIG. 16 is a front perspective view of the denture curing assembly according to the present invention and showing a pressure valve.

FIG. 17 is a perspective view of a resin injection device used in connection with the denture curing assembly according to the present invention.

FIG. 18 is a perspective view of a portion of the pressure valve carried by the pressure cap of the denture curing assembly according to the present invention.

FIG. 19 is a photograph of a foot pedal that is adapted to be connected via tubing to an air compressor and used to move a cylinder within the resin injection device to move resin from within the resin injection device out of the resin injection device and to be used in connection with the denture curing assembly according to the present invention.

FIG. 20 is a perspective view of a resin injection device and showing a cylinder therein in a retracted position.

FIG. 21 is a perspective view of a cap member of the resin injection device illustrated in FIG. 20.

FIG. 22 is a perspective view of a top portion of a resin injection device body member.

FIG. 23 is another perspective view of the cap member of the resin injection device showing threads thereon and that is threadably connectable to the top portion of the resin injection device body member shown in FIG. 22.

FIG. 24 is a perspective view of a denture curing assembly according to an embodiment of the present invention and including an actuator and a piston to move a pressure cap longitudinally and being positioned in communication with a controller.

FIG. 25 is a perspective view of the denture curing assembly shown in FIG. 24.

FIG. 26 is an exploded perspective view of the denture curing assembly shown in FIG. 24 and not showing the controller being connected thereto.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

An embodiment of the invention, as shown and described by the various figures and accompanying text, provides a denture curing assembly 20. Throughout this specification, the invention may be referred to as a denture curing device 20, an assembly 20, a curing assembly 20 or an implant curing assembly 20. As illustrated in the appended figures, the denture curing assembly 20 includes a base 22, and side members 24 extending upwardly therefrom. The denture curing assembly 20 according to the present invention may also include a top 26. The top 26 of the denture curing assembly 20 is connected to an upper portion of each of the side members 24 so that the top 26 extends between the side members 24. Those skilled in the art will appreciate that the denture curing assembly 20 of the present invention may also be used to cure any other type of resin. For example, any other type of dental implant that is made of a resin that requires curing may be cured using the curing assembly 20 of the present invention.

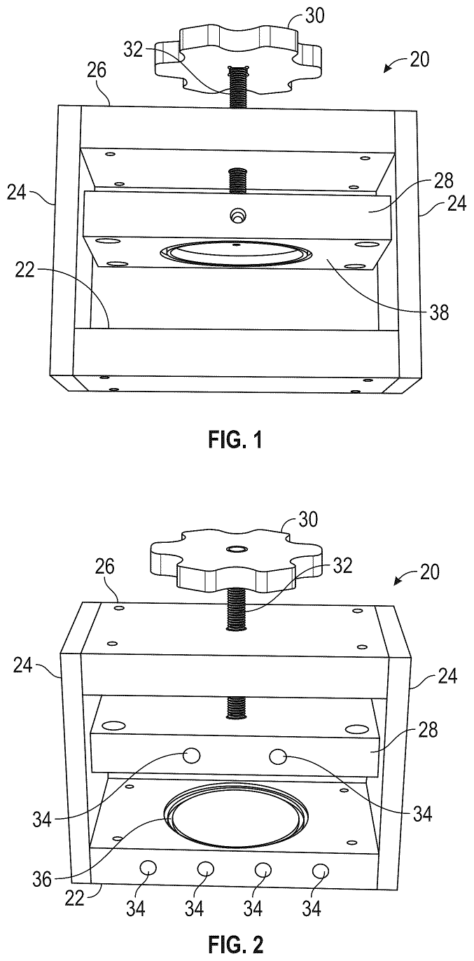

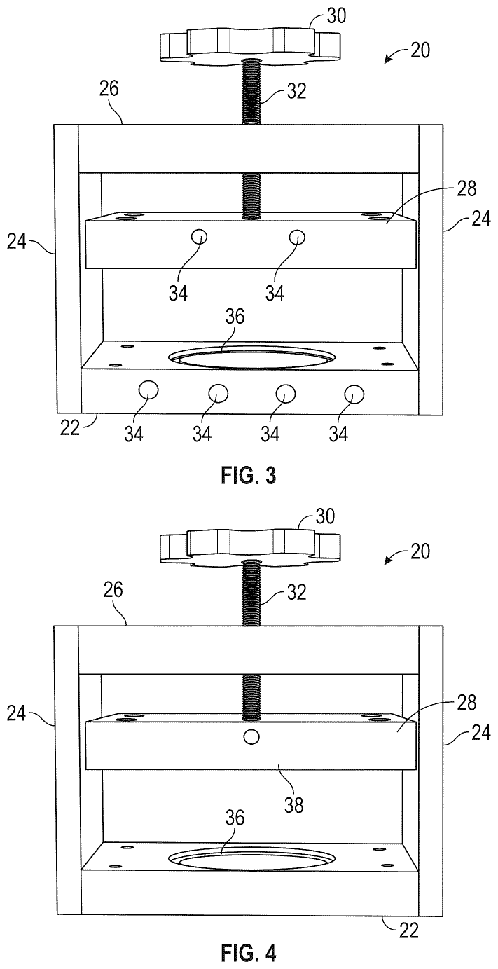

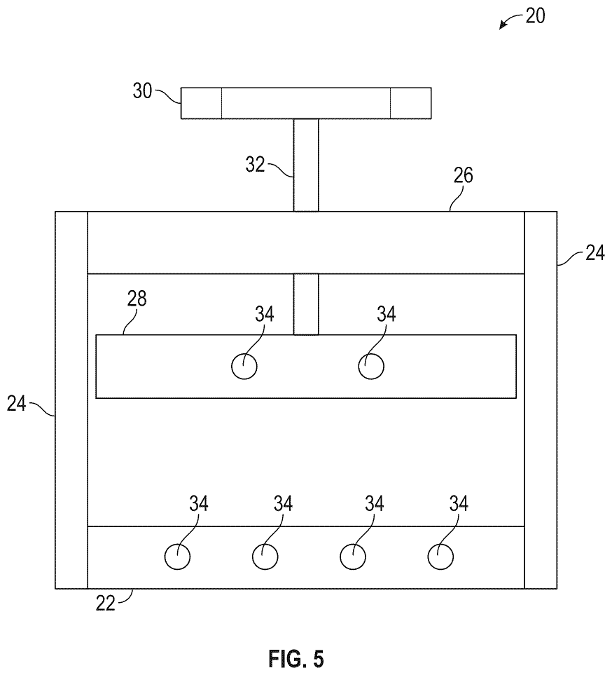

As illustrated in FIGS. 1-5, the base 22 and the top 26 have lengths that are substantially similar. Further, the base 22 and the top 26 are sized to extend between the side member 24. The base 22, the top 24, and the side members 26 are all formed as separate pieces in the illustrated embodiments. However, those skilled in the art will appreciate that the base 22, the top 24, and the side members 26 may be integrally formed as a monolithic unit. In the preferred embodiment of the invention, however, in which the base 22, the top 24, and the side members 26 are separate pieces, the base 22 and the top 24 are connected to the side members 26 and any number of ways. For example, the base 22 in the top 24 may be connected to the side members 26 using fasteners 70, as illustrated in the appended drawings and photographs. More specifically, and with reference to FIG. 7, the fasteners 70 may be bolts, for example, that may extend through portions of the side members 24 and into portions of each of the top 26 and the base 22. Those skilled in the art will also appreciate that the base 22 and the top 26 may be connected to the side members 24 using welding techniques.

As illustrated in the appended figures, the denture curing assembly may also include a pressure cap 28. The pressure cap 28 is longitudinally movable between the side members 24. The pressure cap 28 is preferably sized so as to have a width that is slightly less than the width of both the top 26 and the base 22 of the denture curing assembly 20. More specifically, the pressure cap 28 is preferably sized so that there is a space between end portions of the pressure cap 28 and the side members 24 of the denture curing assembly 20. A shaft 32 may be connected to a top portion of the pressure cap 28. The shaft 32 is threadably carried by the top 26 of the denture curing assembly 20. More specifically, a threaded passageway may be formed in the top 26, and the shaft may threadably engage the threaded passageway. A handle 30 may be connected to an upper portion of the shaft 32. Rotation of the handle 30 may cause rotation of the shaft 32. A lower portion of the shaft 32 is connected to the upper portion of the pressure cap 28.

Rotation of the shaft 32 through the threaded passageway formed in the top 26 causes the pressure cap 28 to be moved between a compressed position and a released position. The compressed position of the pressure cap 28 may be defined as the pressure cap 28 being longitudinally lowered so that it can apply a predetermined amount of force onto an article positioned to be carried by the base 22 of the denture curing assembly 20 according to embodiments of the present invention. The released position of the pressure cap 28 may be defined as a longitudinal position where the lower portion of the pressure cap 28 is not in contact with an article positioned to be carried by the base 22 of the denture curing assembly 20 according to embodiments of the present invention.

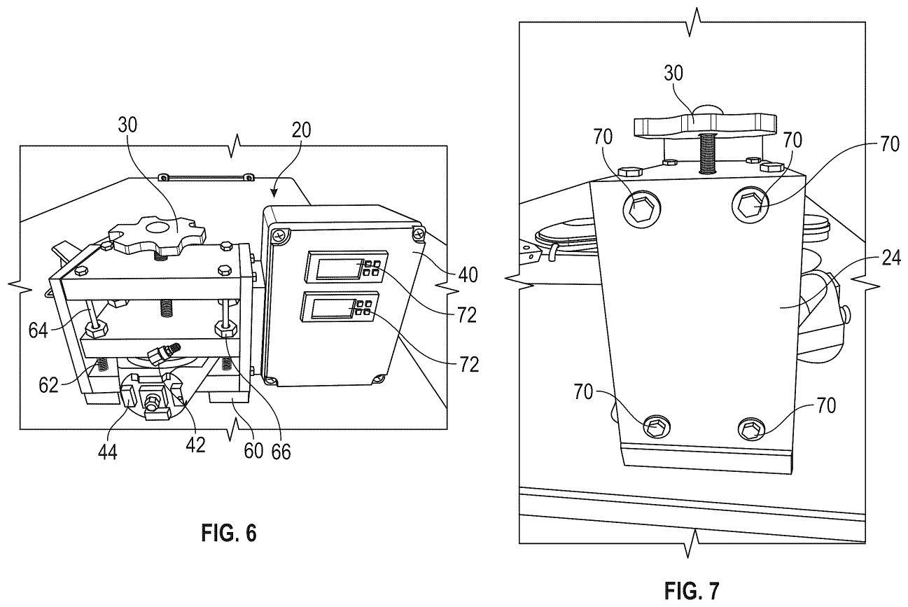

As perhaps best illustrated in FIGS. 6, 8, and 10, the denture curing assembly 20 according to the present invention includes a plurality of legs 64 that extend between the base 22 and the top 26. The pressure cap 28 includes a respective plurality of leg receiving passageways formed therethrough so that the pressure cap 28 may slidably engage the legs 64. Therefore, the pressure cap 28 is slidably moved between the released position and the compressed position along legs 64. A respective plurality of spring members 62 are carried by the legs 64 below the pressure cap 28 and, more specifically, on a portion of the legs 64 that is between an upper portion of the base 22 and a lower portion of the pressure cap 28. Further, a respective plurality of stopper members 66 are carried by the legs 64 and positioned adjacent an upper portion of the pressure cap 28. A plurality of leg members 60 may be carried by the base 22 and, more particularly, may be connected to a lower portion of the base 22. The plurality of leg members 60 may advantageously provide enhanced stability of the denture curing assembly 20 when it is positioned on a surface.

The handle 30 is illustrated as having grip portions. This is advantageous as it may allow a user to readily grip the handle to thereby rotate the shaft 32 and cause the pressure cap 28 to be moved between the compressed position and the released position. Those skilled in the art will appreciate, however, that the pressure cap 28 may be provided by any shape that can be readily gripped by a user to cause rotation thereof and, in turn, cause rotation of the shaft 32 that is connected thereto.

As illustrated in FIGS. 2, 3 and 5, a plurality of heating elements 34 may be included in the denture curing assembly 20 according to embodiments of the present invention. As perhaps best illustrated in FIG. 2, a first plurality of heating elements 34 may be carried by the base 22. A second plurality of heating elements 34 may also be carried by the pressure cap 28. The heating elements 34 are sized to fit within cutouts formed in the base 22 and the pressure cap 28. Although not illustrated in the appended drawings, it is contemplated by the present invention that heating elements may also be carried by the side members 24 to enhance the heating capabilities of the curing process that is used in connection with the denture curing assembly 20 according to embodiments of the present invention.

As illustrated in FIGS. 2, 5 and 8, it will be noticed that there are a first plurality of heating elements 34 in communication with the pressure cap 28 and a second plurality of heating elements 34 in communication with the base 22 of the denture curing assembly. In the embodiments illustrated in the appended figures, the pressure cap 28 includes two heating elements 34 carried thereby and the base 22 includes four heating elements 34. The heating elements 34 are positioned within heating assembly bores that are formed through at least a portion of the base 22 and the pressure cap 28. The heating elements 34 are elongate in nature and are sized to fit within the bores. When activated, the heating elements 34 emit heat into the bores and, in turn, the heat dissipates through the base 22 and the pressure cap. The heat that dissipates through the base 22, however, also dissipates through the side members 24 and the top 26 as the base 22, the side members 24 and the top 26 are in thermal communication with one another. As such, the preferred embodiment of the present invention includes more heating elements 34 in communication with the base 22 to maintain a similar temperature as the pressure cap 28, which is not in thermal communication with any other structural members.

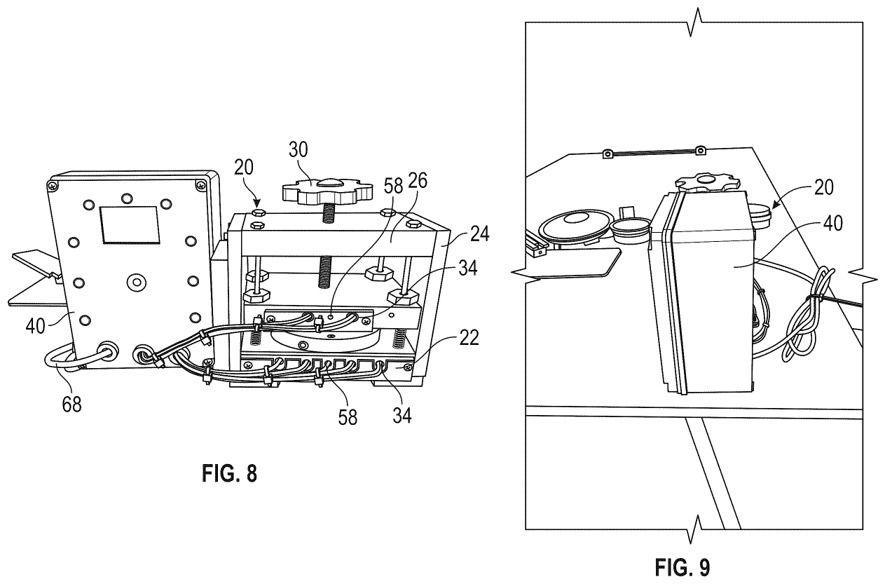

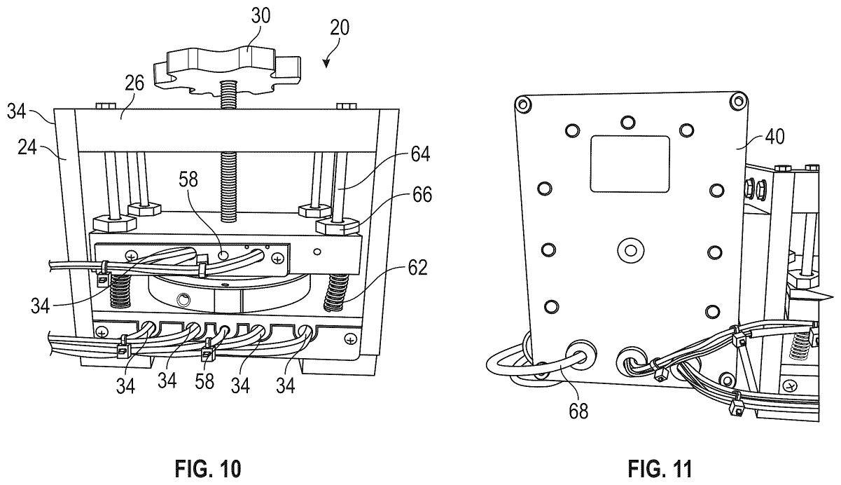

As also illustrated in FIGS. 8 and 10, the denture curing assembly 20 may also include a temperature sensor 58. The temperature sensor 58 is illustratively positioned between the heating elements 34. More specifically, a first temperature sensor 58 may be carried by the base 22, and a second temperature sensor 58 may be carried by the pressure cap 28. The first temperature sensor 58 that is carried by the base 22 may be adapted to detect the temperature of the base 22 based on activation of the heating elements 34 carried by the base 22. The second temperature sensor 58 carried by the pressure cap 28 may be adapted to sense the temperature of the pressure cap 28 based on activation of the heating elements 34 carried by the pressure cap 28. The temperature sensors 58 are illustratively positioned in communication with the controller 40. The controller 40 may also include a power source 68. In the illustrated embodiment, the power source 68 is provided by a plug that is adapted to connect the controller 40 to an outlet, but those skilled in the art will appreciate that the present invention contemplates that batteries may be used as a power source to provide power to the controller.

As illustrated in FIGS. 6, 8, 9, and 11, for example, the denture curing assembly 20 according to embodiments of the present invention may also include a controller 40 that includes at least one temperature gauge 72. The temperature gauge 72 may be positioned in communication with the temperature sensors 58 that are carried by the base 22 and the pressure cap 28. The temperature sensors 58 sense the temperature of the base 22 and the pressure cap 28 as the heating elements 34 are activated to apply heat thereto. The present invention contemplates that the temperature sensor 58 may also be in communication with the denture 46 and or the denture holder 44 to monitor temperature of the denture 46 as it is being cured. Both the temperature gauge 72 and the pressure valve 42 may be in communication with the controller 40 to transmit signals relating to pressure and temperature during the curing process of the article (denture) that is inserted into the denture curing assembly 20 and, more specifically, between the pressure cap 28 and the base 22.

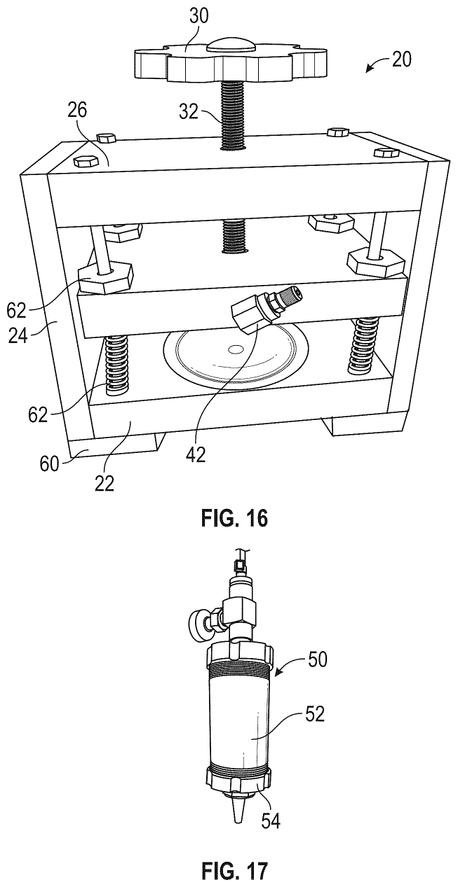

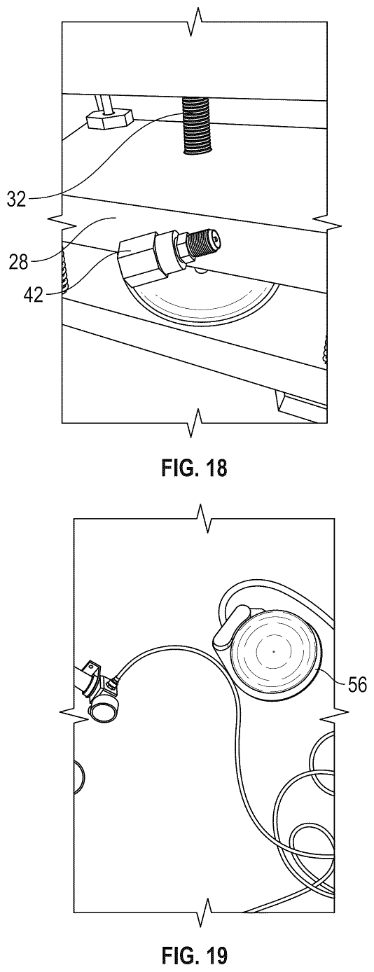

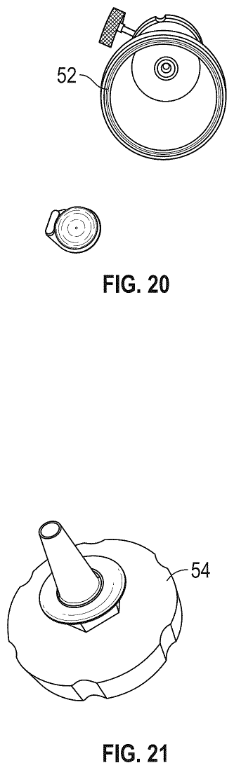

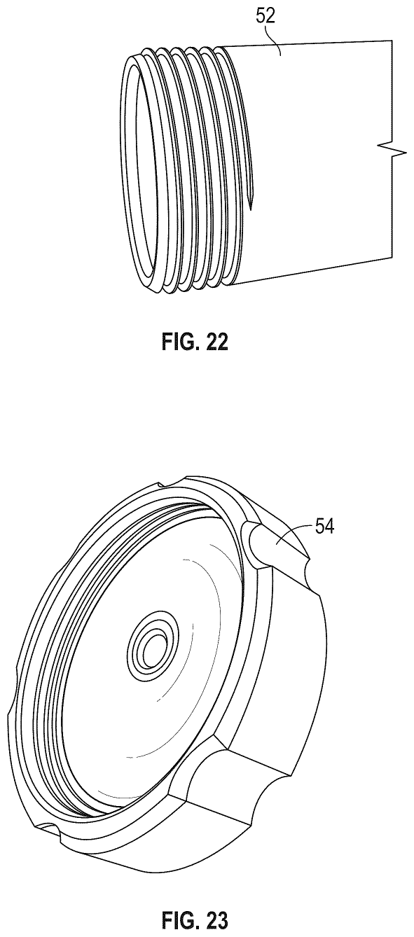

The denture curing assembly 20 according to embodiments of the present invention also includes a pressure valve 42 is connected to and in communication with the pressure cap 28. As illustrated in the FIGS. 6, 12, 16 and 18, the pressure valve 42 is carried by a front portion of the pressure cap 28. The pressure valve 42 may also be used to monitor pressure applied within the denture curing device when the pressure cap 28 is in the compressed position, and pressure, via compressed air pumped through the pressure valve 42, in applied therein. More specifically, a predetermined pressure is applied using air forced through the pressure valve 42 so that the denture 46 is cured under pressure and at a predetermined temperature.

The controller 40 may advantageously be in communication with a network that can be accessible via a global communications network. More specifically, and for example, a mobile device and/or a computing device may receive signals via a global communications network pertaining to the temperature and pressure of the article (denture) being compressed between the pressure cap 28 and the base 22 of the denture curing assembly 20. Further, the controller 40 may be adapted to receive signals from a mobile device or computing device to take certain actions during the curing process. For example, the present invention contemplates that the controller 40 may receive a signal to decrease or increase the temperature of the heating elements 34, or may receive a signal to increase or decrease the pressure exerted by air through the pressure valve 42 on the article (or denture) between the pressure cap 28 and the base 22. Those skilled in the art will appreciate that the controller 40 may also be in communication with the shaft 32 and the handle 30, and that the shaft 32 and the handle 30 may be motorized in some way so that a signal received from the controller 40 can cause the shaft to be rotated to move the pressure cap 28 between the compressed position and the released position.

The denture curing assembly 20 according to the present invention may further include a timer connected to the controller 40. The timer may be used to automatically turn off the heating elements 34 and relieve the pressure being placed on the article by releasing air via the pressure valve 42 and may further be used to automatically move the pressure cap 28 from the compressed position to the released position upon achieving a certain predetermined time. The curing of the resin in the denture 46 may be achieved in any number of ways. For example, it is contemplated that one type of resin may have a first predetermined temperature, pressure and time at which the curing process is ideal, while another type of resin may have a second predetermined temperature, pressure and time at which its curing process is ideal. The timer that is connected to the controller 40 may be programmed to automatically stop the heat and pressure from being applied to the denture 46 when the predetermined times have been reached. The present invention also contemplates that the timer that is connected to the controller may be used to change temperatures and pressures of as needed curing the curing process. The timer can advantageously be pre-programmed to make changes to the pressure and temperature as needed, or may be in communication with the various sensors, i.e., the temperature sensors and the pressure sensors to ensure that the curing process is stopped at the appropriate times.

Referring now more specifically to FIG. 2, additional details relating to the base 22 of the denture curing assembly 20 are now provided. As illustrated, the base 22 may include a cutout 36. This cutout 36 is adapted to receive an article, such as a denture, for example, that is to be positioned thereon. When the article, or denture, is positioned within the confines of the cutout 36 of the base 22, it is ideally placed to receive pressure from the pressure cap 28 as it is moved from the released position to the compressed position.

With additional reference to FIG. 1, additional details of the pressure cap 28 are now provided. A pressure cap cutout 38 may be formed in the lower portion of the pressure cap 28. The pressure cap cutout 38 may be adapted to receive an upper portion of the article, such as the denture, for example, that is to be positioned in the cutout 36 of the base 22. When the article, or denture, is positioned within the confines of the cutout 36 of the base 22, it is ideally placed to receive pressure from the pressure cap 28 as it is moved from the released position to the compressed position, and when the pressure cap 28 is moved from the released position to the compressed position, it is the pressure cap cutout 38 that makes contact with an upper portion of the denture to exert the force necessary to achieve the pressure desired to enhance the curing process.

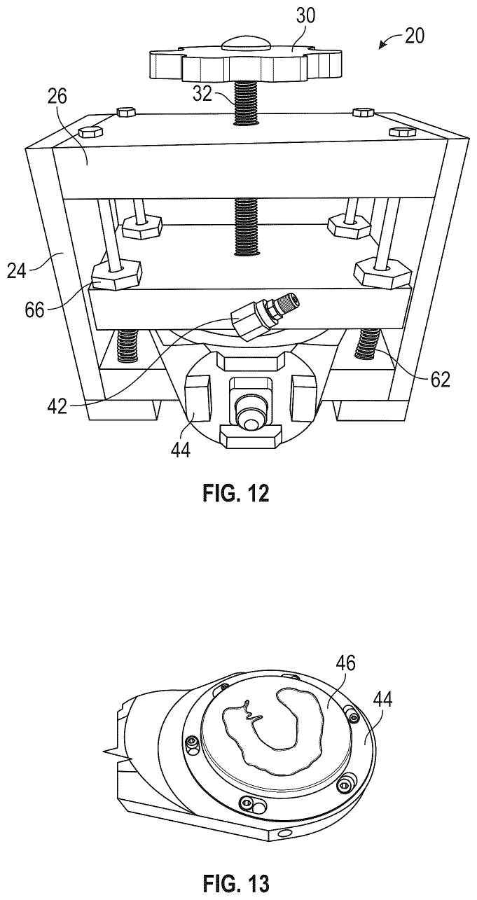

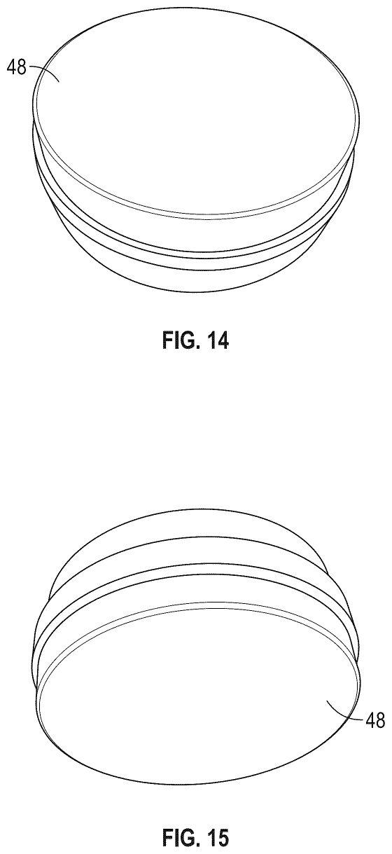

Referring now to FIGS. 12 and 13, the denture curing assembly 20 according to the present invention may also include a denture holder 44 which is adapted to hold the denture 46 in place during the curing process. More specifically, the denture holder 44 secures the denture 46 and is then placed between the base 22 and the pressure cap 28 so that the denture is positioned between the cutout 36 of the base 22 and the pressure cap cutout 38. Accordingly, when the pressure cap 28 is moved from the released position to the compressed position, the denture 46 carried by the denture holder 44 is positioned between the base cutout 36 and the pressure cap cutout 38 and a portion of the denture holder 44 is positioned exterior to the compressed area between the base 22 and the pressure cap 28.

Referring now to FIGS. 14 and 15, a denture disc 48 is shown. The denture disc 48 is the initial piece of molded and pre-shrunk resin that is used when forming the denture 46. The denture disc 48 is initially a whole piece, as illustrated in FIGS. 14 and 15. As is shown in the appended photographs, the denture disc 48 is pink in nature, or the same/similar color to human gums. Of course, human teeth are generally white in nature and, therefore, it would not be desirable to mill the denture disc 48 to the shape of the human gums and teeth. Therefore, the present invention contemplates that a milling machine is used to cut an area in the denture disc 48 to include pockets where teeth are to be located. As illustrated in FIG. 13, a white resin is then filled into the pocket that is formed and the denture 46 is then placed in the denture holder 44 so that the denture disc 48 having the white resin therein can be cured using the denture curing assembly 20 according to the present invention.

Therefore, the advantage of the present invention is that it provides a method to use a pink poly methyl methacrylate (PMMA) disc 48 and mill denture tooth pockets or sockets into the pink disc. Afterwards white tooth color PMMA resin powder and liquid are mixed and injected into the pink disc, which results in the denture 46 illustrated, for example, in FIG. 13. The white tooth color resin is preferably polymerized under high pressure of about 150 psi and high temperature of about 100 degrees centigrade. Once the white tooth color resin has polymerized, the customized PMMA disc can be re-inserted into a CNC mill and the entire denture can be milled as one piece with the denture base in pink and the denture teeth in white.

Referring now to FIG. 17, and 19-23, details regarding a resin injection device 50 are no provided. The resin injection device 50 is used to inject the white PMMA resin into the pockets formed in the denture disc 48 to form the denture 46. As illustrated, the resin injection device 50 includes a resin injection device body member 52 and a resin injection device cap 54. An interior portion of the resin injection device body member 52 includes a cam or a plunger type of device that is sized to have a diameter slightly smaller than an inner diameter of the resin injection device body member 52. The resin injection device is connectible to an air compressor and a foot pedal 56 is used to control compressed air being inserted into the resin injection device so that when the resin injection device cap 54 is connected to the resin injection device body member 52, the white PMMA resin carried by an interior portion of the resin injection device may be expelled into the pocket formed in the denture disc 48. FIG. 13 shows the denture 46 after the white PMMA resin is injected into the pockets formed in the denture disc 48.

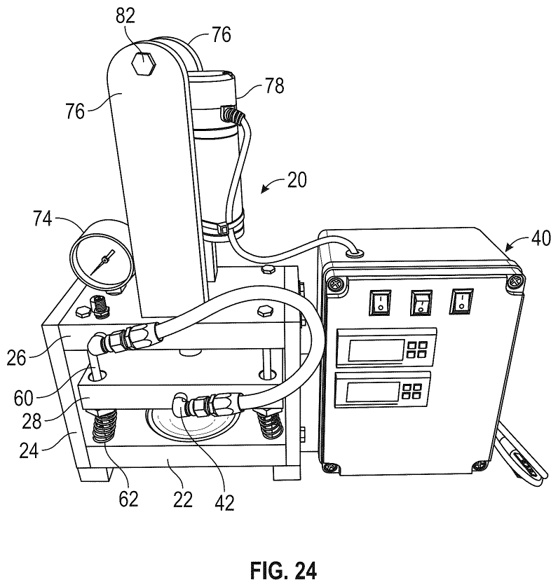

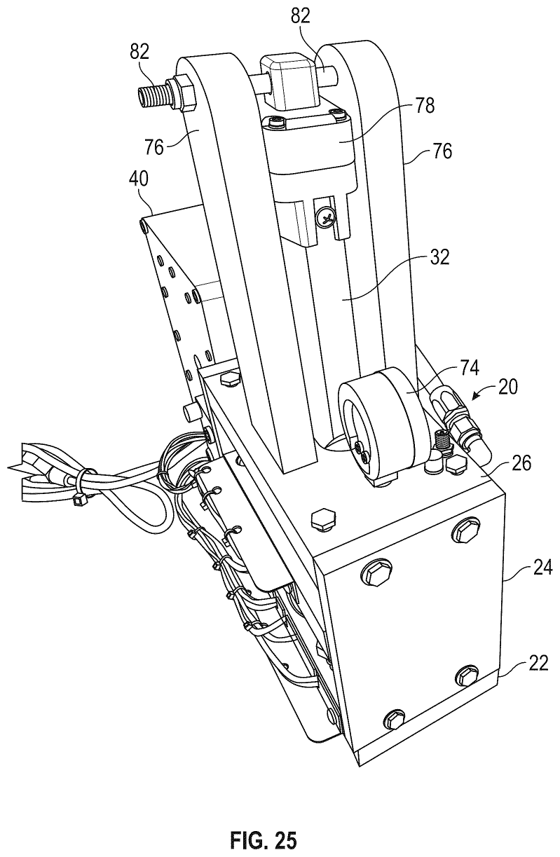

Referring now to FIG. 24-26, an additional embodiment of the denture curing assembly 20 according to the present invention is now described in greater detail. More particularly, in this embodiment of the denture curing assembly 20, the pressure cap 28 is moved between the compressed position and the released position using an actuator 78 that is connected to the shaft 32. More specifically, the denture curing assembly 20 may include a pair of actuator side members 76 connected to and extending upwardly from the top 26. The denture curing assembly 20 may also include an actuator 78 connected to the actuator side members 76. In this embodiment of the denture curing assembly 20, the shaft 32 is connected to the actuator 78. More particularly, a first end of the shaft 32 is connected to the pressure cap 28, and a second end of the shaft 32, which is opposite the first end of the shaft 32, is connected to the actuator 78. Movement of the actuator 78 causes movement of the shaft 32 and, in turn, movement of the shaft 32 causes the pressure cap 28 to move between the released position and the compressed position.

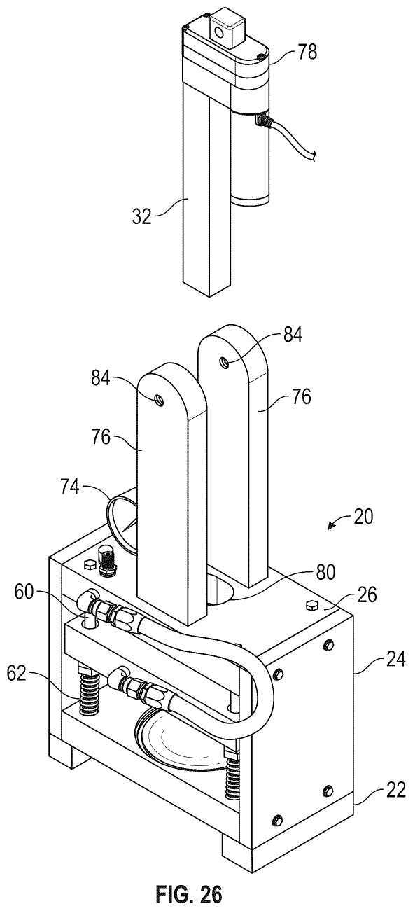

As perhaps best illustrated in the exploded view of the denture curing assembly 20 of the present invention in FIG. 26, the top 26 may include a passageway 80 formed therethrough. The passageway 80 is preferably sized to receive the shaft 32. The passageway 80 is illustrated as being formed in a media portion of the top 26, but those skilled in the art will appreciate that the passageway 80 may be formed in any portion of the top while still carrying out the benefits, features and advantages of the present invention. Further, a bolt 82, or other similar structural member, may be used to connect the actuator 78 to the actuator side members 76. The bold 82 is adapted to be passed through bolt receiving passageways 84 formed in an upper portion of the actuator side members 76, and also through a passageway formed in an upper portion of the actuator 78. This advantageously allows the actuator 78 to be positioned between the pair of actuator side members 76 and provides stability to the denture curing assembly when the pressure cap 28 is moved to the compressed position. A pressure gauge 74 may illustratively be positioned on the top 26 to advantageously allow a user to monitor the pressure applied by the pressure cap 28 to the article that is being cured using the denture curing assembly 20 according to the present invention.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the description of the invention. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A denture curing assembly, comprising:
a base;
a pair of side members extending upwardly from the base;
a top connected to upper portions of the side members and extending between the side members, the top having a passageway formed in a medial portion thereof;
a pressure cap positioned between the side members and longitudinally movable between a released position and a compressed position;
a shaft connected to the pressure cap to slidably engage the passageway formed in the medial portion of the top, wherein longitudinal movement of the shaft causes the pressure cap to move between the released position and the compressed position;
a plurality of heating elements carried by at least one of the base and the pressure cap; and
a pressure valve in communication with the pressure cap and configured to apply pressure to an article positioned between the base and the pressure cap.

2. The denture curing assembly of claim 1, wherein the plurality of heating elements comprises a first plurality of heating elements carried by the base and a second plurality of heating elements carried by the pressure cap.

3. The denture curing assembly of claim 1, further comprising at least one temperature sensor carried by at least one of the base and the pressure cap.

4. The denture curing assembly of claim 3, further comprising a controller in communication with the at least one temperature sensor and the plurality of heating elements; and at least one temperature gauge in communication with the at least one temperature sensor.

5. The denture curing assembly of claim 4, further comprising a timer connected to the controller, wherein the timer is configured to automatically deactivate the plurality of heating elements upon achieving a predetermined time.

6. The denture curing assembly of claim 1, further comprising a plurality of legs extending between the base and the top, wherein the pressure cap includes a respective plurality of leg receiving passageways formed therethrough such that the pressure cap slidably engages the plurality of legs.

7. The denture curing assembly of claim 6, further comprising a respective plurality of spring members carried by the plurality of legs and positioned between an upper portion of the base and a lower portion of the pressure cap.

8. The denture curing assembly of claim 1, wherein the base includes a cutout adapted to receive a denture holder, and wherein the pressure cap includes a pressure cap cutout formed in a lower portion thereof and adapted to receive an upper portion of the denture holder.

9. The denture curing assembly of claim 1, wherein the pressure valve is configured to apply compressed air at a pressure of approximately 150 psi to the article positioned between the base and the pressure cap.

10. The denture curing assembly of claim 1, further comprising a pair of actuator side members connected to and extending upwardly from the top; an actuator connected to the actuator side members; wherein the shaft is connected to the actuator;
and wherein movement of the actuator causes movement of the shaft to move the pressure cap between the released position and the compressed position.

11. The denture curing assembly of claim 1, wherein the shaft is threaded; wherein the shaft is threadably carried by the top; wherein rotation of the shaft causes the pressure cap to move between the released position and the compressed position; and further comprising a handle connected to an upper portion of the shaft.

12. A denture curing assembly, comprising:
a base;
a pair of side members extending upwardly from the base;
a top connected to upper portions of the side members and extending between the side members, the top having a passageway formed in a medial portion thereof;
a pressure cap positioned between the side members and longitudinally movable between a released position and a compressed position;
a pair of actuator side members connected to and extending upwardly from the top;
an actuator connected to the actuator side members; wherein the shaft is connected to an actuator;
a shaft connected to the pressure cap on a first end thereof, and connected to the actuator on a second end thereof opposite the first end, the shaft being adapted to slidably engage the passageway formed in the medial portion of the top;
a plurality of heating elements carried by at least one of the base and the pressure cap;
a pressure valve in communication with the pressure cap and configured to apply pressure to an article positioned between the base and the pressure cap; and
at least one temperature sensor carried by at least one of the base and the pressure cap;
wherein the base includes a cutout adapted to receive a denture holder;
wherein the pressure cap includes a pressure cap cutout formed in a lower portion thereof and adapted to receive an upper portion of the denture holder; and
wherein movement of the actuator causes longitudinal movement of the shaft to cause the pressure cap to move between the released position and the compressed position.

13. The denture curing assembly of claim 12, wherein the plurality of heating elements comprises a first plurality of heating elements carried by the base and a second plurality of heating elements carried by the pressure cap.

14. The denture curing assembly of claim 12, further comprising a controller in communication with the at least one temperature sensor and the plurality of heating elements; at least one temperature gauge in communication with the at least one temperature sensor; and a timer connected to the controller; wherein the timer is configured to automatically deactivate the plurality of heating elements upon achieving a predetermined time.

15. The denture curing assembly of claim 12, further comprising a plurality of legs extending between the base and the top; and a respective plurality of spring members carried between the plurality of legs and positioned between an upper portion of the base and a lower portion of the pressure cap; and wherein the pressure cap includes a respective plurality of leg receiving passageways formed therethrough such that the pressure cap slidably engages the plurality of legs.

16. A denture curing assembly, comprising:
a base;
a pair of side members extending upwardly from the base;
a top connected to upper portions of the side members and extending between the side members, the top having a threaded passageway formed in a medial portion thereof;
a pressure cap positioned between the side members and longitudinally movable between a released position and a compressed position;
a threaded shaft connected to the pressure cap to threadably engage the threaded passageway formed in the medial portion of the top, wherein longitudinal movement of the shaft causes the pressure cap to move between the released position and the compressed position;
a handle connected to an upper portion of the shaft.
a plurality of heating elements carried by at least one of the base and the pressure cap;
a pressure valve in communication with the pressure cap and configured to apply pressure to an article positioned between the base and the pressure cap;
at least one temperature sensor carried by at least one of the base and the pressure cap;
a controller in communication with the at least one temperature sensor and the plurality of heating elements;
at least one temperature gauge in communication with the at least one temperature sensor; and
a timer connected to the controller, wherein the timer is configured to automatically deactivate the plurality of heating elements upon achieving a predetermined time;
wherein rotation of the shaft causes the pressure cap to move between the released position and the compressed position.

17. The denture curing assembly of claim 16, wherein the plurality of heating elements comprises a first plurality of heating elements carried by the base and a second plurality of heating elements carried by the pressure cap.

18. The denture curing assembly of claim 16, further comprising a plurality of legs extending between the base and the top; and a respective plurality of spring members carried between the plurality of legs and positioned between an upper portion of the base and a lower portion of the pressure cap; and wherein the pressure cap includes a respective plurality of leg receiving passageways formed therethrough such that the pressure cap slidably engages the plurality of legs.

19. The denture curing assembly of claim 16, wherein the base includes a cutout adapted to receive a denture holder, and wherein the pressure cap includes a pressure cap cutout formed in a lower portion thereof and adapted to receive an upper portion of the denture holder.

20. The denture curing assembly of claim 16, further comprising a pair of actuator side members connected to and extending upwardly from the top; an actuator connected to the actuator side members; wherein the shaft is connected to an actuator; and wherein movement of the actuator causes movement of the shaft to move the pressure cap between the released position and the compressed position.
